(19) United States
(12) Patent Application Publication
(10) Pub. No.: US 2012/0112884 A1
(43) Pub. Date: May 10, 2012

(54) APPARATUS AND METHOD FOR DETECTING COLLISION OF RFID TAGS

(75) Inventors: Ji Hoon BAE, Daejeon-si (KR); Kwang Soo Cho, Daejeon-si (KR); Dong Han Lee, Daejeon-si (KR); Man Sik Park, Daejeon-si (KR); Chan Won Park, Daejeon-si (KR)

(73) Assignee: Electronics and Telecommunications Research Institute, Daejeon (KR)

(21) Appl. No.: 13/186,824

(22) Filed: Jul. 20, 2011

(30) Foreign Application Priority Data
Nov. 10, 2010 (KR) 10-2010-0111424

(51) Int. Cl. G06K 7/01

(52) U.S. Cl. 340/10.1

(57) ABSTRACT

The present invention relates to an apparatus and method for detecting the collision of Radio Frequency IDentification (RFID) tags. In the apparatus and method for detecting the collision of RFID tags, when a subcarrier signal from which a carrier signal has been removed by a reader ASK analog demodulation device is inputted to a baseband receiver, a peak signal for the received tag signal is generated, and useful information about the generated peak signal within a symbol section is extracted. In the case where a collision is generated because two or more tags send signals to an RFID reader at the same time when the RFID reader communicates with the tags, the RFID reader can effectively detect the collision between the tags.

Priority to Korean patent application number 10-2010-0111424 filed on Nov. 10, 2010, the entire disclosure of which is incorporated by reference herein, is claimed.

### BACKGROUND OF THE INVENTION

1. Field of the Invention

The present invention relates to an apparatus and method for detecting the collision of Radio Frequency IDentification (RFID) tags and, more particularly, to an apparatus and method for detecting the collision of RFID tags, which is capable of detecting a collision generated from received tag signals.

2. Discussion of the Related Art

An RFID technique is used to detect, trace, and manage things, animals, and persons to which tags are attached by reading or writing information from the tags having pieces of unique ID information in a contactless way using the radio frequency.

An RFID system using the RFID technique includes a plurality of tags (or electronic tags or transponders) configured to have pieces of unique ID information and attached to things or animals and an RFID reader or interrogator configured to read or write the information of the tag. The RFID system is classified into a mutual induction method and an electromagnetic wave method according to a mutual communication method between the reader and the tag, classified into an active type and a passive type according to whether the tag is operated by its own power, and classified into a long wave type, a medium wave type, a short wave type, and a ultra-short wave type, and a high ultra-short wave type according to the frequency used.

Meanwhile, a conventional collision detection method includes an edge trigger method. In the collision detection method using the edge trigger method, a collision is determined to have occurred if falling and rising edges are not generated according to the symbol sequence of data at an intermediate position within one symbol section on the basis of the principle that a transition from a high to a low is generated (i.e., the falling edge) at the intermediate position of the symbol within the symbol section in case of “0” in a Manchester baseband signal and a transition from a low to a high is generated (i.e., the rising edge) at the intermediate position of the symbol within the symbol section in case of “1” in the Manchester baseband signal.

However, an apparatus and method for detecting a collision using the edge trigger method is problematic in that performance may be deteriorated because of white noises.

### SUMMARY OF THE INVENTION

It is, therefore, an object of the present invention to provide an apparatus and method for detecting the collision of RFID tags, which is capable of more accurately determining whether a collision has been generated although DC offset distortion noise or white noise exists, by generating a peak signal, having positive and negative levels, at an intermediate position of one symbol from a received tag signal, extracting useful peak information from the peak signal during one symbol section, and determining whether a collision has been generated in tag signals based on the extracted useful peak information.

An apparatus for detecting the collision of RFID tags according to an aspect of the present invention includes a peak signal generator for generating a peak signal from the tag signal modulated in the phase or amplitude shift method and then received and a collision detection unit for extracting peak information from the generated peak signal and determining the collision based on the extracted peak information.

The peak signal generator may generate the peak signal, having a positive or negative level according to a symbol data value, at an intermediate position corresponding to a half cycle of one symbol section.

The collision detection unit may include a peak information extractor for extracting the peak information from the peak signal and a collision determination unit for determining the collision based on the peak information received from the peak information extractor.

The peak information extractor may determine a peak point at which the slope of the peak signal shifts from the positive to the negative or from the negative to the positive within a search range section as the peak information.

The peak information extractor may determine a position and a size in which a maximum value of the peak signal is generated within the search range section as the peak information.

The apparatus may further include a reference level generator for providing reference level information to the collision detection unit so that the collision detection unit determines the collision.

The collision determination unit may determine the collision for the received tag signal based on the reference level provided by the reference level generator, when determining the collision based on the peak information received from the peak information extractor.

The reference level generator may determine the reference level using the preamble section of the received tag signal.

The reference level generator may receive the peak signal from the peak signal generator and determine the mean value of peak point values of the peak signal existing in the preamble section.

A method of detecting the collision of RFID tags according to another aspect of the present invention include generating a peak signal from the tag signal modulated in the phase or amplitude shift method and then received, extracting peak information from the generated peak signal, and determining the collision based on the extracted peak information.

The peak signal may be generated in the positive or negative level according to a symbol data value at an intermediate position corresponding to a half cycle of one symbol section.

The peak information may be extracted from the peak signal, and a peak point at which the slope of the peak signal shifts from the positive to the negative or from the negative to the positive within a search range section may be determined as the peak information.

The peak information may be extracted from the peak signal, and a position and a size in which a maximum value of the peak signal is generated within the search range section may be determined as the peak information.

The method may further include searching for a maximum value of the peak signal; and if an absolute value of the maximum value falls within a predetermined range, determining that the peak information exists, and if the absolute value of the maximum value does not fall within the predetermined range, determining that the peak information does not exist.

The method may further include receiving the peak information, determining whether the peak information exists within a predetermined search section, determining whether the peak signal exists within the range of a predetermined reference level, and if, as a result of the determination, the peak information and the peak signal are determined to exist, determining that the collision has not been generated.

The method may further include, if, as a result of the determination, the peak information is determined not to exist or the peak signal is determined not to exist within the range of the reference level, determining that the collision has been generated.

In the case where the collision is determined based on the received peak information, the collision for the received tag signal may be determined using the reference level.

The reference level may be determined using the preamble section of the received tag signal.

The peak signal may be received, and the mean value of peak point values of the received peak signal existing in a preamble section may be determined as the reference level.

In an RFID communication method according to the present invention, a peak signal is generated from a tag signal modulated in the phase or amplitude shift method and then received. Peak information is extracted from the generated peak signal, and collision information is acquired based on the extracted peak information. Dynamic slots are allocated to a plurality of tags based on the collision information.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram of an apparatus for detecting the collision of RFID tags for detecting the collision of tag signals according to an embodiment of the present invention;

FIG. 2 is an exemplary diagram showing the peak signals of Manchester subcarrier signals outputted through a peak signal generator according to an embodiment of the present invention;

FIG. 3 is a flowchart illustrating an algorithm for extracting useful peak information used to determine the collision of tags from peak signals received from a peak information extractor according to an embodiment of the present invention;

FIG. 4 is a flowchart illustrating an algorithm for determining whether a collision has been generated in received tag signals on the basis of information outputted by the peak information extractor, information outputted by a preamble detector, and information outputted by a reference level generator according to an embodiment of the present invention;

FIG. 5 is an exemplary diagram showing peak signals existing in a preamble section in which the reference level generator provides a reference level to a collision determination unit according to an embodiment of the present invention;

FIG. 6 is a block diagram showing that the reference level generator generates a reference level to be used to determine a collision using peak signals existing in the preamble section according to an embodiment of the present invention;

FIG. 7 is a block diagram of a first filter which constitutes the reference level generator of FIG. 6 according to an embodiment of the present invention;

FIG. 8 is an exemplary graph showing the levels of a signal in the preamble section of a Manchester subcarrier signal having DC offset noise, which is outputted through a first step and a second step of FIG. 6 according to an embodiment of the present invention;

FIG. 9 is an exemplary diagram showing the results of output in the case where one Manchester subcarrier signal passes through the apparatus for detecting the collision of RFID tags according to the embodiment of the present invention;

FIG. 10 is an exemplary diagram showing the results of output in the case where two Manchester subcarrier signals pass through the apparatus for detecting the collision of RFID tags according to the embodiment of the present invention; and

FIG. 11 is an exemplary diagram showing the results of output in the case where a number of Manchester subcarrier signals pass through the apparatus for detecting the collision of RFID tags according to the embodiment of the present invention.

### DETAILED DESCRIPTION OF THE EMBODIMENTS

Hereinafter, some embodiments of the present invention are described in detail with reference to the accompanying drawings. Terms used in the embodiments of the present invention are defined by taking their functions in the present invention into consideration and may be varied according to an intention of a user or an operator or to usual practices. Accordingly, the definition should be understood on the basis of the contents of all the embodiments of the specification.

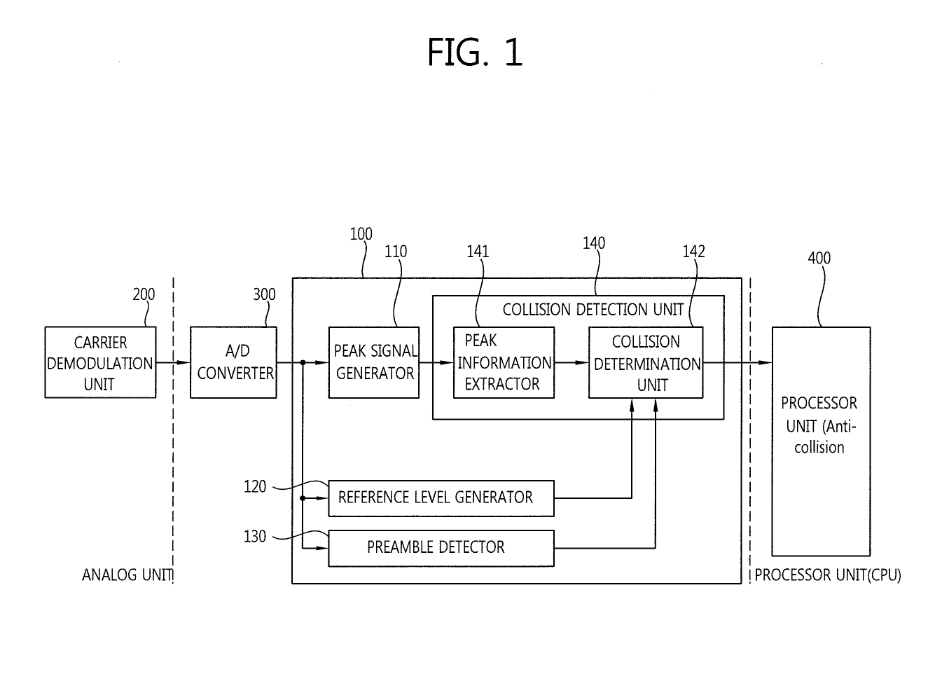

FIG. 1 is a block diagram of an apparatus for detecting the collision of RFID tags for determining a collision between Manchester subcarrier signals according to an embodiment of the present invention.

As shown in FIG. 1, the RFID tag collision detection apparatus 100 according to the embodiment of the present invention basically includes a peak signal generator 110 having an interface with a carrier demodulation unit 200 and an Analog/Digital (A/D) converter 300 and generating peak signals from subcarrier signals, a reference level generator 120, a preamble detector 130, and a collision detection unit 140 having a peak information extractor 141 and a collision determination unit 142.

Each of the elements of the RFID tag collision detection apparatus 100 according to the embodiment of the present invention is described in detail below with reference to FIG. 1.

The peak signal generator 110 functions to generate peak signals having positive and negative levels on the basis of symbol data values at an intermediate position within one symbol section from received tag signals.

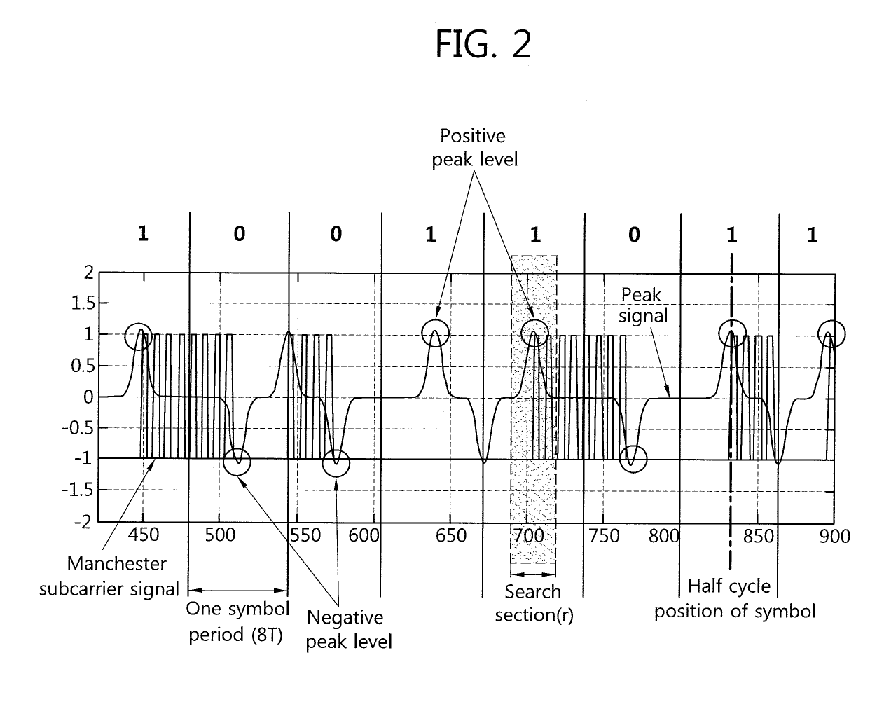

FIG. 2 is a diagram showing peak signals generated when Manchester subcarrier signals pass through the peak signal generator according to an embodiment of the present invention. From FIG. 2, it can be seen that the peak signal generated by the peak signal generator 110 has a negative level in case of data ‘0’ and a positive level in case of data ‘1’ at an intermediate position within one symbol section of the subcarrier signal.

The generated peak signal is advantageous in that DC offset noise is removed from the generated peak signal by the peak signal generator 110 and the generated peak signal is strong against white noise, although the DC offset noise exists in received tag signals.

The contents to be described herein as embodiments of the present invention are based on that a peak signal has a negative level in case of data ‘0’ and a positive level in case of data ‘1’ as described above. However, the peak signal may have a negative level in case of data ‘1’ and a positive level in case of data ‘0’ as described above.

The peak information extractor 141 functions to receive the peak signals having the positive or negative level, outputted by the peak signal generator 110, is and extract useful peak information for determining a collision. The peak information extractor 141 extracts a useful peak point at which the slope of the peak signal generated at the intermediate position of one symbol shifts from the positive to the negative or from the negative to the positive.

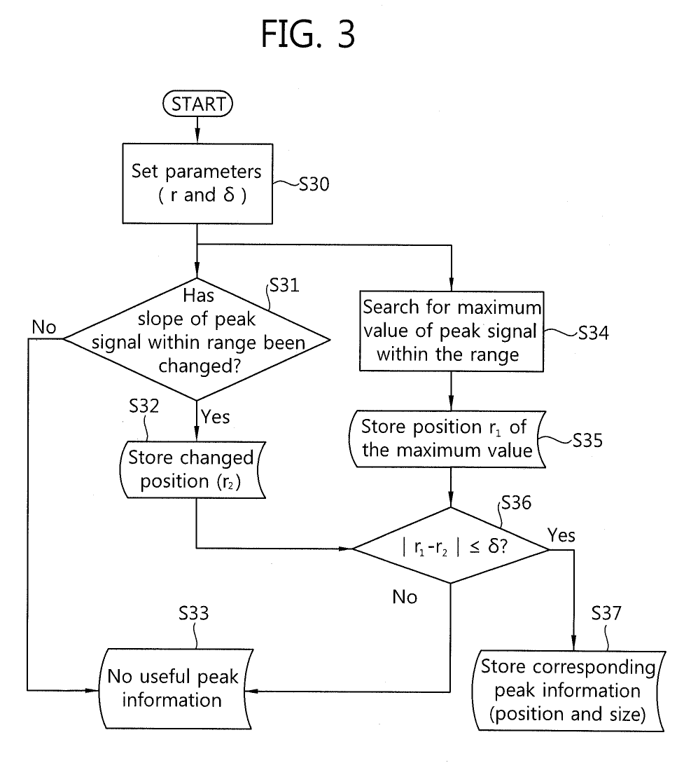

FIG. 3 is a flowchart illustrating an algorithm that the peak information extractor extracts the useful peak information. Referring to FIG. 3, the peak information extractor 141 sets parameters, such as a search range section r and a determination range δ at step S30, determines whether the slope of the peak signal is changed within the search range section r at step S31, and searches for a maximum value of the peak signal within the search range section r at step S34.

If, as a result of the determination at step S31, the slope of the peak signal changes is determined to be changed within the search range section r, the peak information extractor 141 stores a changed position r₂ at step S32. If, as a result of the determination at step S31, the slope of the peak signal changes is determined not to be changed within the search range section r, the peak information extractor 141 determines that there is no useful peak information at step S33. Furthermore, if the maximum value is searched for within the search range section r at step S34, the peak information extractor 141 stores the position r₁ of the maximum value at step S35.

Next, the peak information extractor 141 determines whether an absolute distance between the position r₁ of the maximum value of the peak signal within the search range section r, defined by a user, within one symbol section and a position r₂ where the slope of the peak signal is changed from the positive to the negative or from the negative to the positive within the search range is equal to or smaller than the determination range δ, such as that shown in Equation 1. If, as a result of the determination at step S36, the absolute distance is determined to be equal to or smaller than the determination range δ, the peak information extractor 141 determines that there is useful peak information and stores the position and size of the peak information at step S37. If, as a result of the determination at step S36, the absolute distance is determined not to be equal to or smaller than the determination range δ, the peak information extractor 141 determines that there is no useful peak information at step S33.

|r₁−r₂|≦δ [Equation 1]

The r, r₁, r₂, and δ may be set to predetermined optimal values or may be randomly set by a user according to an RFID communication environment and condition.

Meanwhile, the collision determination unit 142 of the RFID tag collision detection apparatus 100 according to the embodiment of the present invention functions to finally determine whether a collision has been generated in tag signals received by a reader on the basis of pieces of information received from the peak information extractor 141 and the reference level generator 120 and to send the determined information to a processor unit 400 for performing anti-collision with a tag.

In the case where one reader communicates with several tags, the HF Gen2 standard regulates that several slots are allocated using a Q random-based anti-collision algorithm and the tags select one of the slots and communicate with the reader. Furthermore, the HF Gen2 standard adopts a dynamic slot allocation method of increasing the number of slots to communicate with tags by increasing a Q value if the number of tags is many and of decreasing the number of slots to communicate with tags by decreasing a Q value if the number of tags is small.

Accordingly, if two or more tags send signals to the reader through one slot at the same time, a collision is generated. In this case, an ability to send accurate collision detection-related information about whether a collision has been generated in tag signals received by the processor unit 400 for performing anti-collision between a plurality of tags can be determined by a reader which performs anti-collision between the plurality of tags. Accordingly, there are advantages in that the consumption of slots can be prevented by more efficiently predicting the number of tags and the speed of communication with the tags can be improved.

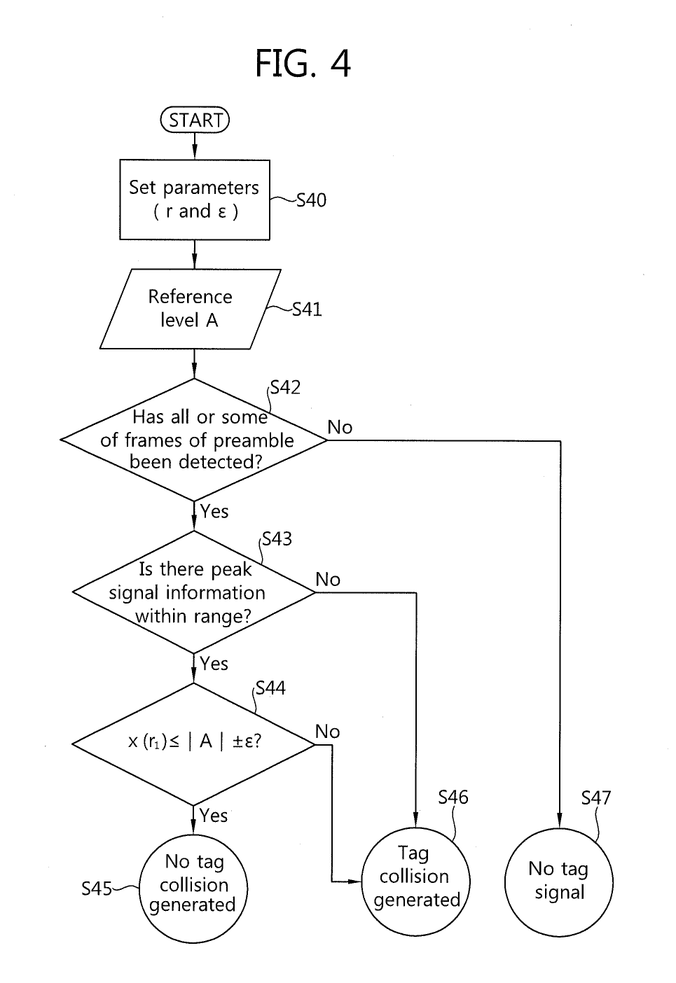

The collision determination unit 142 of the present invention is intended to achieve the above objects and configured to determine whether there is a collision between received tag signals by performing the collision determination algorithm of FIG. 4. Referring to FIG. 4, the collision determination unit 142 sets parameter values r and ε at step S40, sets a reference level A at step S41, and then performs the algorithm. Next, the collision determination unit 142 determines whether all or some of the frames of a preamble have been detected at step S42. If, as a result of the determination, all or some of the frames of the preamble are determined not to have been detected, the collision determination unit 142 determines that there is no tag signal at step S47. If, as a result of the determination at step S42, all or some of the frames of the preamble are determined to have been detected, the collision determination unit 142 performs the following steps for determining whether there is a collision.

At a first step: After detecting the preamble, the collision determination unit 142 determines whether the peak signal information extracted by the peak information extractor 141 exists in the search range section r, defined by the user, during one symbol section at step S43.

At a second step: If, at the first step, the peak signal information is determined to exist in the search range section r, the collision determination unit 142 determines whether the size of the peak signal exists within the range of the reference level provided by the reference level generator 120 at step S44. Here, ‘ε’ may be set to a predetermined optimal value or may be randomly set by a user according to an RFID communication environment and condition.

At a third step 3: If a useful peak signal exists and the size of the peak signal exists within the range of the reference level as in the first step and the second step, the collision determination unit 142 generates information regarding that a collision has not been generated at step S45. If any one of the first step and the second step is not satisfied, the collision determination unit 142 generates information regarding that a collision has been generated at step S46.

In the algorithm, the preamble detector 130 functions to extract the preamble constituting the received tag signals. The preamble detector 130 receives the tag signals from the A/D converter 300, extracts information about whether a preamble or some frames of the preamble have been detected, and sends the information to the collision determination unit 142.

As described above, the collision determination algorithm performed by the collision determination unit 142 continues to perform whether a collision has been generated if all or some of the frames of the preamble are detected, outputs information about that there is no tag signal if all or some of the frames of the preamble are not detected, and provides the information to the processor unit 400 for performing an anti-collision algorithm.

Meanwhile, the reference level generator 120 functions to receive the tag signals from the A/D converter 300 or the peak signals from the peak signal generator 110 and generate a reference level necessary to determine a collision during the preamble section of the signal.

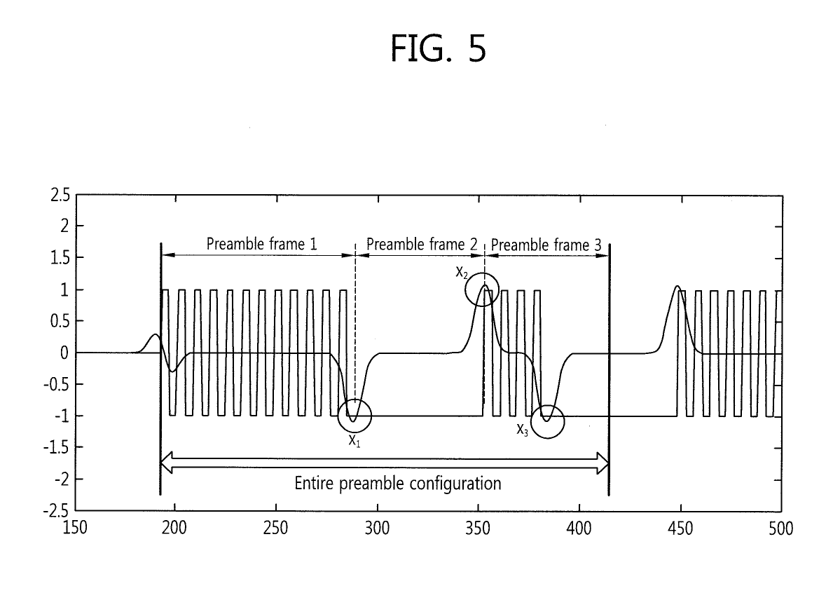

A method of extracting the reference level may include receiving the peak signals from the peak signal generator 110 as shown in FIG. 5 and determining the mean value (or average value) of peak point values of the peak signal, existing in the preamble section, as the reference level according to Equation 2.

$$A = \frac{1}{3} {\sum }_{i = 1}^{3} ( {x}_{1} + {x}_{2} + {x}_{3} ) \qquad [ Equation 2 ]$$

Alternatively, the method of extracting the reference level may include directly receiving the tag signal from the A/D converter 300 and extracting the reference level necessary to determine a collision using a section in which subcarrier cycles constituting a preamble consecutively exist (preamble frame 1). The method is performed by eliminating DC offset noise if the DC offset noise exists, generating a signal from which subcarrier cycles are removed using a moving average filter, and then determining the mean value (or average value) of size levels of the generated signal as the reference level.

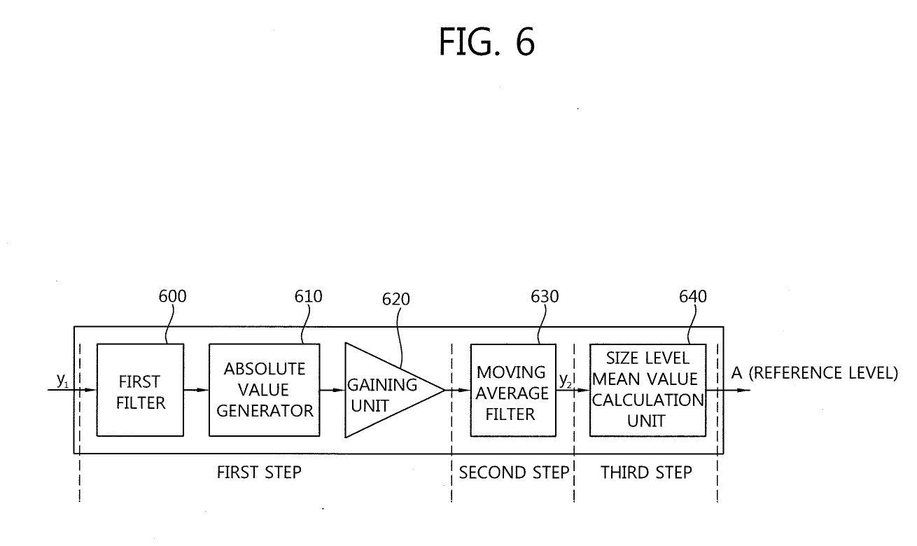

FIG. 6 is a block diagram for extracting the reference level in the latter method. The block diagram may include a step of removing DC offset noise using a first filter 600 (first step), an absolute value generator 610, and a gaining unit 620, a step of generating a rectangular pulse signal by removing subcarriers using a moving average filter 630 (second step), and a step of calculating the mean value (or average value) of size levels of the generated rectangular pulse signal using a size level mean value calculation unit 640 (third step).

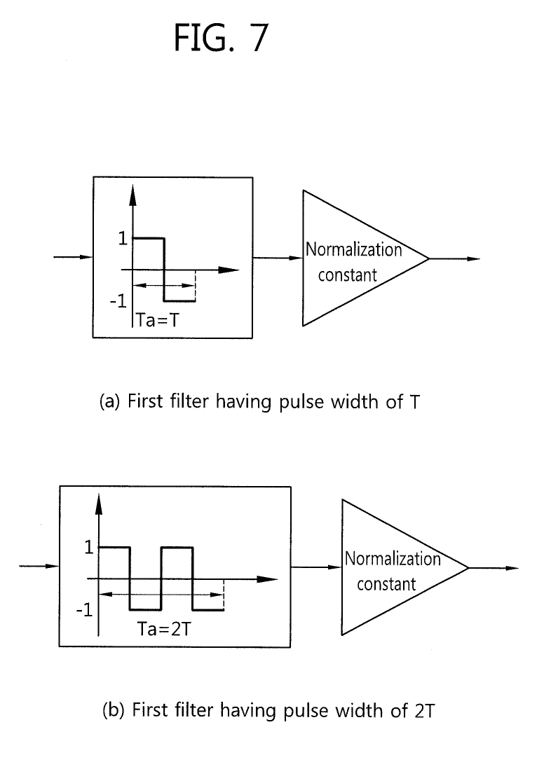

FIG. 7 shows a construction of the first filter 600 of the reference level generator 120 shown in FIG. 6. The first filter 600 has the same form as a subcarrier cycle as shown in FIG. 7(a) or a form having two or more consecutive subcarrier cycles as shown in FIG. 7b, which may be selected according to an intention of a user.

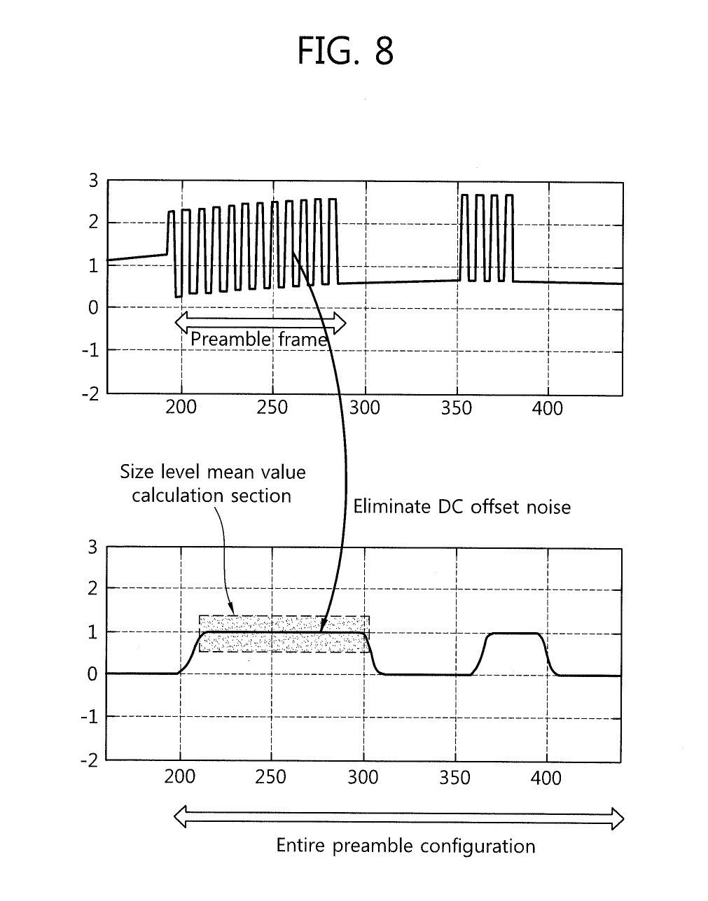

FIG. 8 illustrates a detailed embodiment in which the reference level necessary to determine a collision is generated using the above-described latter method. A figure on the upper side of FIG. 8 shows the preamble section of a Manchester subcarrier signal including DC offset noise.

A figure on the lower side of FIG. 8 is a graph showing the levels of the signal outputted through the step of eliminating DC offset noise and the step of generating the rectangular pulse signal by removing subcarriers in FIG. 6.

Accordingly, the reference level obtained by calculating the mean value of the size levels of the rectangular pulse signal of FIG. 8 from which DC offset noise has been efficiently eliminated and used to determine a collision can be provided to the collision determination unit 142. Although DC offset noise exists in a tag signal received by a baseband receiver via the A/D converter 300, the reference level from which the DC offset noise has been effectively eliminated and which is strong against a shift of the size can be provided to the collision determination unit 142.

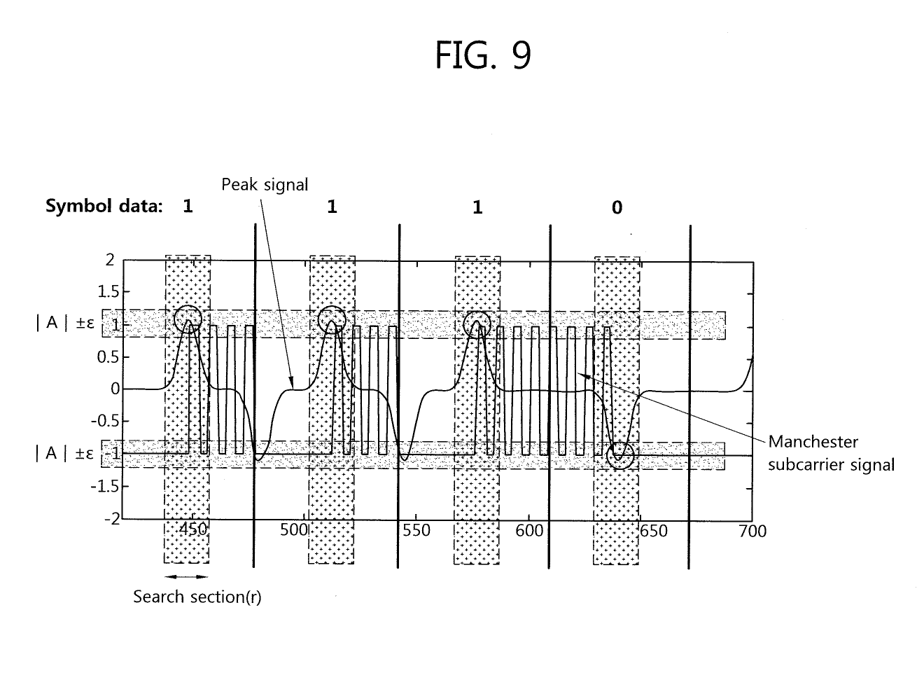

Meanwhile, in order to help understanding of the results of the operation of the RFID collision detection apparatus 100 proposed by the embodiment of the present invention, FIG. 9 shows the results of output when one Manchester subcarrier signal passes through the RFID collision detection apparatus 100.

As in the results of FIG. 9, a peak signal having a positive or negative level exists during a predetermined search section within one symbol section, and peak information to satisfy the algorithm of FIG. 3 is extracted from the peak signal. Accordingly, it can be seen that a collision has not been generated because the condition that a collision has not been generated is satisfied according to the collision determination algorithm of FIG. 4.

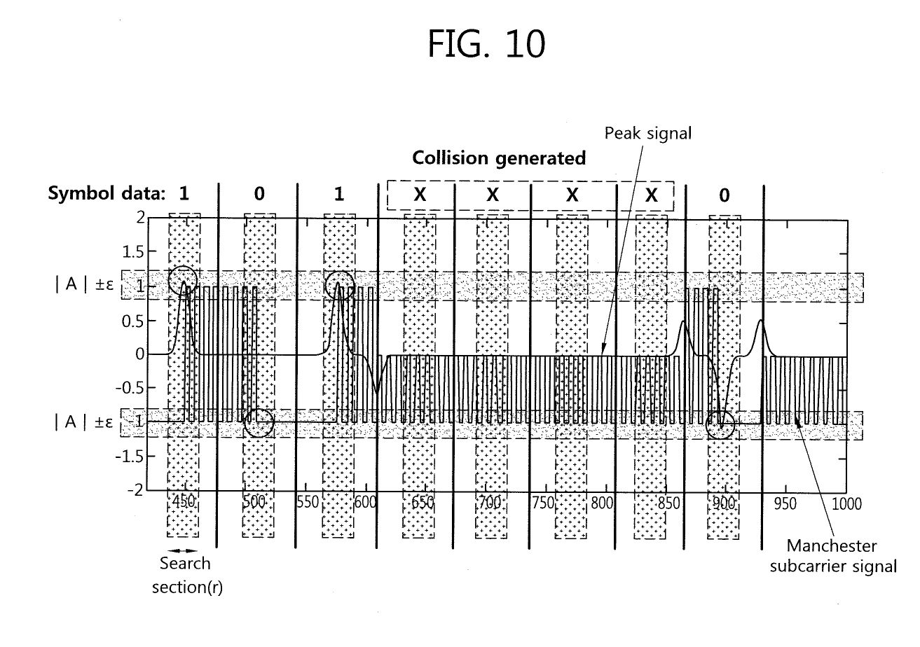

On the other hand, FIG. 10 shows the results of output in the case where two Manchester subcarrier tag signals pass through the RFID collision detection apparatus 100 according to the embodiment of the present invention at the same time. The results of FIG. 10 correspond to a case where useful peak information has been not extracted using the algorithm of FIG. 3 because a peak signal is not generated during a predetermined search section r within one symbol section and the collision determination unit 142 has determined that a collision has been generated because the useful peak information is not obtained using the collision determination algorithm of FIG. 4.

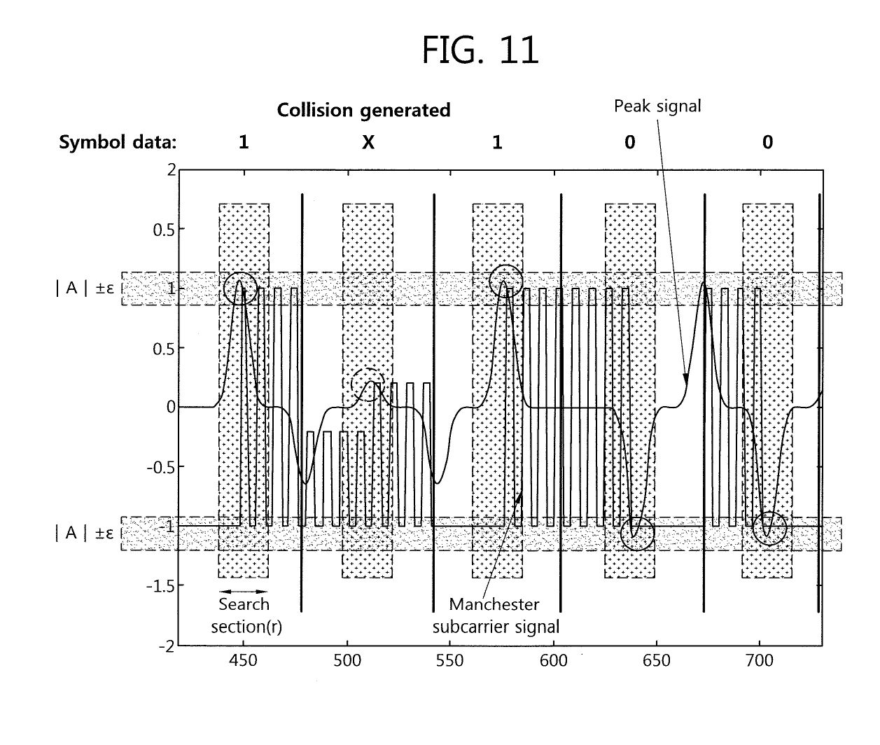

FIG. 11 shows the results of output in the case where a number of Manchester subcarrier tag signals pass through the RFID collision detection apparatus 100 at the same time. The results of FIG. 11 correspond to a case where although a peak signal has been generated during a predetermined search section r within one symbol section, the collision determination unit 142 has determined that a collision has been generated because the peak signal does not exist within the range of the reference level (|A|±ε) which is used to determine a collision in the collision determination algorithm of FIG. 4.

Finally, the processor unit 400 for performing the Q random-based anti-collision algorithm defined in the HF Gen2 standard receives information from the collision determination unit 142 and performs an operation based on the information. The information relates to whether or not a collision has been generated in received tag signals. The information is written in memory or a register so that the processor unit 400 can perform an efficient anti-collision algorithm with reference to the memory or the register.

The apparatus and method for detecting the collision of RFID tags according to the present invention is advantageous in that it can more accurately detect information about the generation of a collision through tag collision detection devices, such as the peak signal generator, the peak information extractor, and the collision determination algorithm, although a tag signal, including DC offset noise or white noise, is inputted to the tag collision detection devices constituting a reader reception device in a passive type RFID environment.

While the invention has been shown and described with respect to the some embodiments, it will be understood by those skilled in the art that various changes and modifications may be made without departing from the spirit and scope of the invention as defined in the following claims.

What is claimed is:

1. An apparatus for detecting a collision of Radio Frequency Identification (RFID) tags, the apparatus comprising:
a peak signal generator for generating a peak signal from the tag signal modulated in a phase or amplitude shift method and received; and
a collision detection unit for extracting peak information from the generated peak signal and determining the collision based on the extracted peak information.

2. The apparatus as claimed in claim 1, wherein the peak signal generator generates the peak signal, having a positive or negative level according to a symbol data value, at an intermediate position corresponding to a half cycle of one symbol section.

3. The apparatus as claimed in claim 1, wherein the collision detection unit comprises:
a peak information extractor for extracting the peak information from the peak signal; and
a collision determination unit for determining the collision based on the peak information received from the peak information extractor.

4. The apparatus as claimed in claim 3, wherein the peak information extractor determines a peak point at which a slope of the peak signal shifts from a positive to a negative or from a negative to a positive within a search range section as the peak information.

5. The apparatus as claimed in claim 3, wherein the peak information extractor determines a position and a size in which a maximum value of the peak signal is generated within a search range section as the peak information.

6. The apparatus as claimed in claim 3, further comprising a reference level generator for providing reference level information to the collision detection unit so that the collision detection unit determines the collision.

7. The apparatus as claimed in claim 6, wherein the collision determination unit determines the collision for the received tag signal based on the reference level provided by the reference level generator, when determining the collision based on the peak information received from the peak information extractor.

8. The apparatus as claimed in claim 6, wherein the reference level generator determines the reference level using a preamble section of the received tag signal.

9. The apparatus as claimed in claim 6, wherein the reference level generator receives the peak signal from the peak signal generator and determines a mean value of peak point values of the peak signal existing in a preamble section.

10. A method of detecting a collision of RFID tags, the method comprising:
generating a peak signal from the tag signal modulated in a phase or amplitude shift method and received; and
extracting peak information from the generated peak signal and determining the collision based on the extracted peak information.

11. The method as claimed in claim 10, wherein the peak signal is generated in a positive or negative level according to a symbol data value at an intermediate position corresponding to a half cycle of one symbol section.

12. The method as claimed in claim 10, wherein:
the peak information is extracted from the peak signal, and
a peak point at which a slope of the peak signal shifts from a positive to a negative or from a negative to a positive within a search range section is determined as the peak information.

13. The method as claimed in claim 10, wherein:
the peak information is extracted from the peak signal, and
a position and a size in which a maximum value of the peak signal is generated within a search range section are determined as the peak information.

14. The method as claimed in claim 10, further comprising:
searching for a maximum value of the peak signal; and
if an absolute value of the maximum value falls within a predetermined range, determining that the peak information exists, and if the absolute value of the maximum value does not fall within the predetermined range, determining that the peak information does not exist.

15. The method as claimed in claim 10, further comprising:
receiving the peak information;
determining whether the peak information exists within a predetermined search section;
determining whether the peak signal exists within a range of a predetermined reference level; and
if, as a result of the determination, the peak information and the peak signal are determined to exist, determining that the collision has not been generated.

16. The method as claimed in claim 15, further comprising, if, as a result of the determination, the peak information is determined not to exist or the peak signal is determined not to exist within the range of the reference level, determining that the collision has been generated.

17. The method as claimed in claim 15, wherein in a case where the collision is determined based on the received peak information, the collision for the received tag signal is determined using the reference level.

18. The method as claimed in claim 15, wherein the reference level is determined using a preamble section of the received tag signal.

19. The method as claimed in claim 15, wherein the peak signal is received, and a mean value of peak point values of the received peak signal existing in a preamble section is determined as the reference level.
